(19) United States
(12) Patent Application Publication
(10) Pub. No.: US 2005/0102844 A1
(43) Pub. Date: May 19, 2005

(54) Dual bladed hand held cutting instrument

(76) Inventor: Carl J. Addis, Fort Collins, CO (US)

Correspondence Address: SHERIDAN ROSS PC, 1560 BROADWAY, SUITE 1200, DENVER, CO, 80202, US

(21) Appl. No.: 11/004,480

(22) Filed: Dec. 3, 2004

Related U.S. Application Data
(63) Continuation-in-part of application No. 29/193,833, filed on Nov. 14, 2003, now Pat. No. D501126.

(51) Int. Cl. B26B 29/00

(52) U.S. Cl. 30/299; 30/294; 30/304

(57) ABSTRACT

The present invention relates to hand-held cutting instruments, and more specifically to a two blade cutting instrument with a shrouded handle which can be used in two distinct positions of use.

This application claims priority to pending U.S. Des. patent application Ser. No. 29/193,833, filed on Nov. 14, 2003 and is incorporated herein in its entirety by reference.

### FIELD OF THE INVENTION

The present application relates to cutting instruments, and more specifically a field dressing knife with an enclosed handle to protect a user's hand during use.

### BACKGROUND OF THE INVENTION

Cutting instruments and knives have been known for centuries and have been used during the skinning and butchering of wild game and other animals. More typically, these knives are single bladed instruments which are used for cutting or dismembering a portion of an animal. Other types of knives which use a “gut hook” are typically used for gutting or skinning an animal, and which includes a hook shaped guide portion which is positioned underneath the skin and pulled along an appendage or along an intestinal track to prevent the unwanted cutting of the intestines or muscle. With both prior art designs, there is generally nothing to protect a user's fingers from inadvertently coming in contact with the cutting edge of the knife, and thus creating an injury. Typically a skinning knife and a gutting knife are two distinct instruments and hunters, sportsman, butchers and others using these cutting instruments are required to carry two distinct knives for two different purposes.

One attempt to solve the previously mentioned problem of requiring two distinct cutting instruments was addressed by the Wyoming Knife Corporation of Fort Collins, Colo. The Wyoming Knife Corporation developed a field dressing knife which includes both a skinning blade and a gutting blade. The two blades are positioned in substantially opposing positions and the instrument includes a finger ring which includes two substantially circular rings which are adapted to receive a user's first two fingers. During use the knife handle can be rotated from a first position of use, wherein the skinning blade is in position for use, and a second position of use wherein the gutting blade positioned in the hook-shaped guide is used. Although this novel cutting instrument solves the problem of requiring two distinct knives, the finger ring still exposes a user's fingers for possible contact with a cutting edge, and finger fatigue becomes a pronounced problem after skinning and butchering a large game animal. Thus, a significant need exists for a cutting instrument which has an enclosed handle for the protection of a user's fingers, and is ergonomically adapted to fit a user's fingers and thumb in two distinct positions of use.

### SUMMARY OF THE INVENTION

It is thus one aspect of the present invention to provide a field cutting instrument which has a substantially enclosed handle to protect a user's fingers during use. Accordingly, in one embodiment of the present invention a totally enclosed handle is provided which shrouds a user's fingers, while providing a position on the exterior perimeter for a user's thumb.

It is another embodiment of the present invention to provide an enclosed handle for a cutting instrument which has an ergonomic interior and exterior profile for fitting a user's hand. More specifically, in one embodiment of the present invention a substantially enclosed handle is provided with an ergonomic profile adapted to fit a user's hand and thus prevent hand fatigue. In another embodiment of the present invention, the handle is comprised at least partially of soft pliable material which further conforms to a user's hand to additionally reduce hand fatigue during the skinning or butchering operation of a game animal.

It is a further aspect of the present invention to provide a field cutting instrument which has both a skinning blade, and a gutting blade and which in one embodiment the blades are positioned in substantially opposing directions. Thus, the cutting instrument can be used for the two distinct purposes of gutting and/or skinning an animal. In one embodiment of the present invention, the skinning blade and the gutting blade are integrally interconnected and may be quickly removed and replaced with a replacement blade to assure sharpness.

It is another aspect of the present invention to provide a safe cutting instrument which has blade covers which are removably interconnected to both the skinning knife and the gutting knife, and thus is designed to prevent inadvertent injury. Thus, in one embodiment of the present invention, blade covers are provided which are made out of plastic, canvas, cardboard or other materials which can be slid or snapped in place and selectively positioned over the sharpened edge of either the skinning blade and/or the gutting blade when not in use.

Accordingly, in one embodiment of the present invention, a dual bladed, hand held cutting instrument is provided which generally comprises an enclosed handle comprising a lower end, an upper end, an exterior perimeter edge and an interior edge, wherein the user's fingers are adapted for positioning within the enclosed handle and the user's thumb is adapted for positioning on an exterior edge of the enclosed handle, wherein the user's fingers are generally shrouded from contacting a first blade or a second blade of the dual bladed cutting instrument. As appreciated by one skilled in the art, individual users may have preferences regarding the exact positioning of the fingers and thumb. Thus, it is not critical that the thumb remain on only the exterior perimeter edge, but may also wrap around the handle or be positioned at least partially within the enclosed handle.

### BRIEF DESCRIPTION OF THE DRAWINGS

FIG. 1 is a front elevation view of one embodiment of the present invention and generally depicts an enclosed handle, a blade support member, a skinning blade and a gut hook blade;

FIG. 2 is a top elevation view of the invention shown in FIG. 1;

FIG. 3 is a right elevation view of the invention shown in FIG. 1;

FIG. 4 is a rear elevation view of the invention shown in FIG. 1;

FIG. 5 is a left elevation view of the invention shown in FIG. 1;

FIG. 6 is a bottom elevation view of the invention shown in FIG. 1; and

FIG. 7 is a rear perspective view of the invention shown in FIG. 1, and further identifying a removable blade cover.

### DETAILED DESCRIPTION

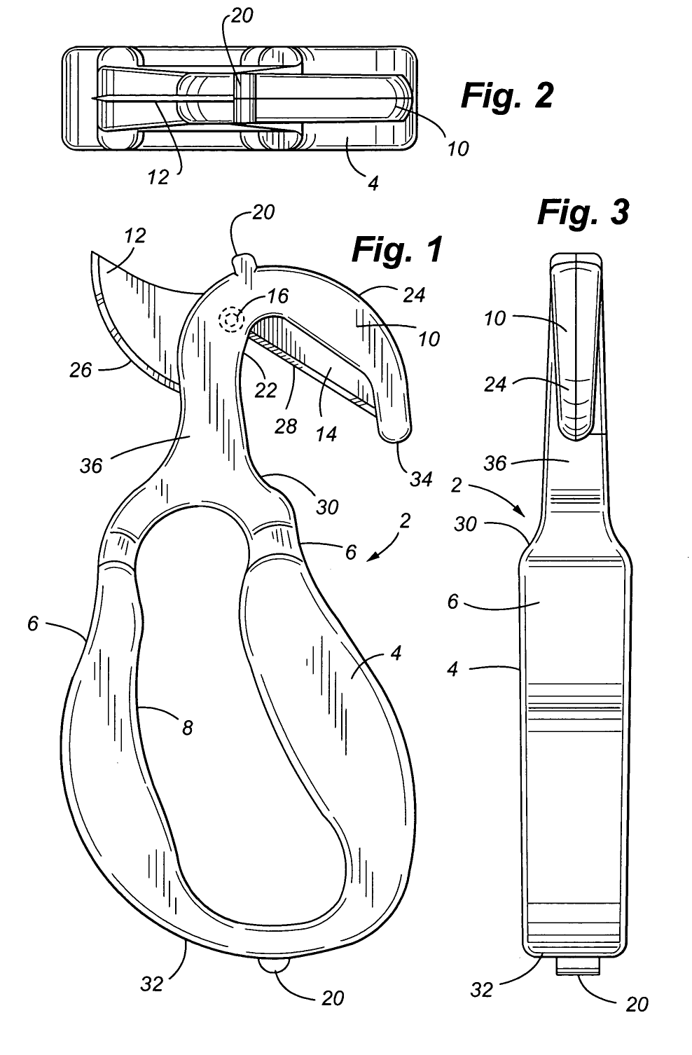

Referring now to the drawings, FIGS. 1-7 depict one embodiment of the present invention. More specifically, FIG. 1 represents a front elevation view of one embodiment of the invention, and generally includes a handle 4 which is interconnected on an upper portion to a handle a blade support member 36, which further includes a gut hook 10. The handle 4 generally comprises a handle outer perimeter shape 6, a handle internal perimeter shape 8, an upper end 30 and a lower end 32. In one embodiment of the present invention, the handle lower end 32 or upper end 30 may include one or more protruding studs 20. The protruding stud 20 may be used for cleaning the entrails of a fish, and as a scraping tool for other animals as well.

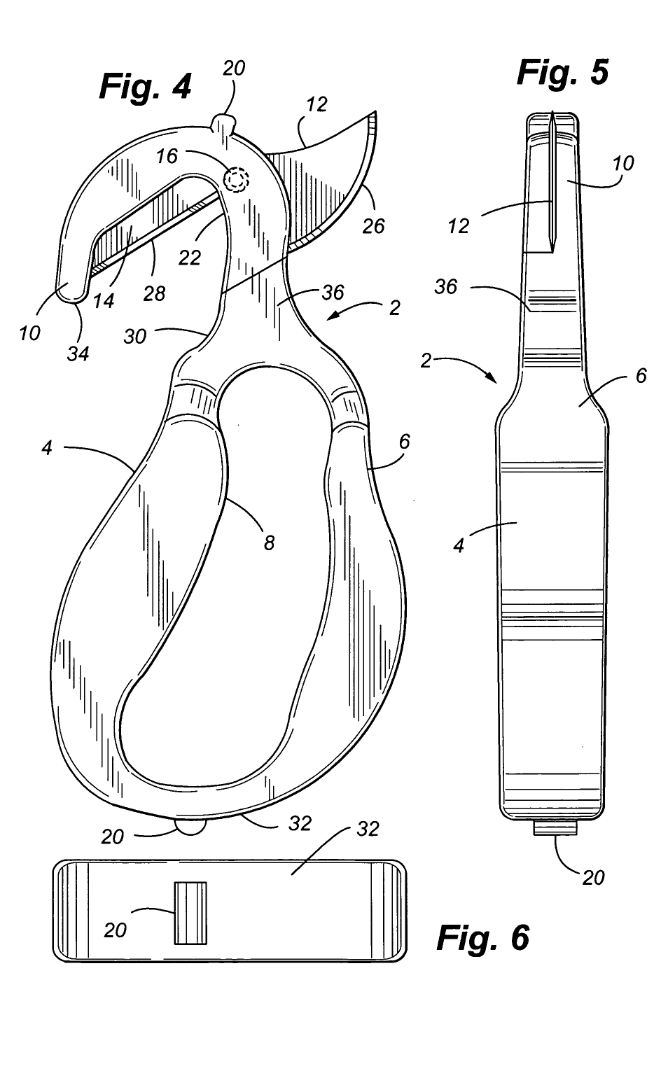

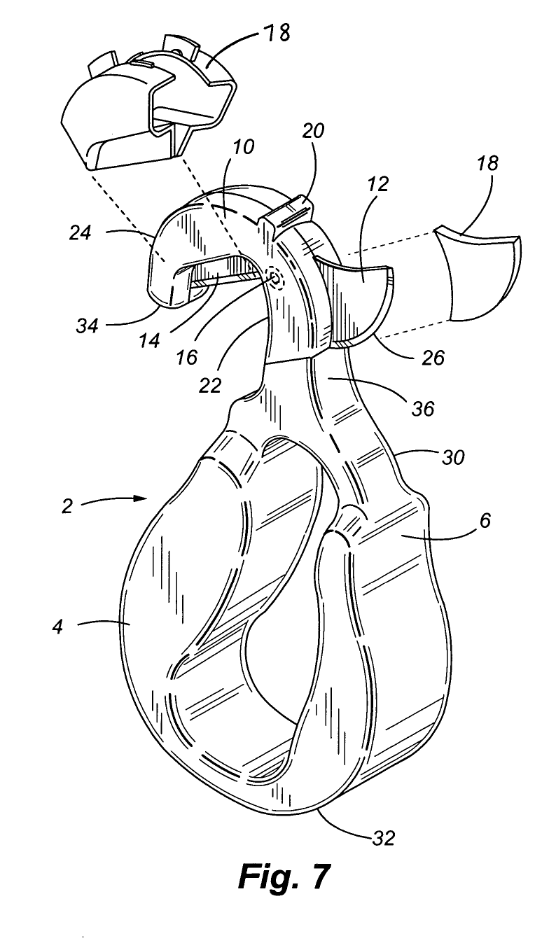

Referring now to FIGS. 2 and 3, a top elevation and right elevation view of the embodiment shown in FIG. 1 is provided herein. FIG. 4 represents a rear elevation view, while FIG. 5 represents a left elevation view and FIG. 6 a bottom elevation view of the embodiment shown in FIG. 1. FIG. 7 is a front perspective view of the embodiment shown in FIG. 1, and further depicts and optional blade guard 18 shown removed from the skinning blade 12.

Referring now to FIGS. 1 and 7, one embodiment of the present invention is shown herein, and which generally depicts an enclosed handle which has a sufficient internal dimension to completely shroud and enclose a user's hand during use. The handle is designed with an outer perimeter edge 6 and an internal perimeter shape 8 which can be used in one of two positions depending on which blade is being used. In either position, a user's thumb is generally positioned on the handle outer perimeter edge 6, while all four fingers are positioned within the handle on the handle internal perimeter edge 8. To help facilitate the ergonomics of the handle and remove tension in the hand during use, the handle 4 may be comprised of a soft rubber or plastic material which is compressible and suitable for gripping.

The present invention is generally designed for two distinct uses, including the use of a skinning blade 12 in a first position of use and a gutting blade 14 in a second position of use. During use of the skinning blade 12, the user's fingers are generally positioned within the enclosure of the knife handle 4, while the thumb is positioned proximate to an outer perimeter edge while the skinning blade 12 is repeatedly drawn in a top to bottom motion along the blade cutting edge 26.

The gutting blade 14 is generally used for gutting a big game animal such as a deer, elk, or moose, and is used to make an incision along the body cavity without damaging the internal organs, or other muscle or tissue. The gutting blade 14 may also be used in a skinning operation along the four legs of the game animal and prevents cutting unwanted muscle. To utilize the gutting blade 14, a user's fingers are generally positioned within the handle, while the thumb is positioned on an outer perimeter shape 6. The gutting blade 14 is then pulled with the hand to selectively cut the skin, while the handle gut hook leading edge 34 prevents unwanted cutting. As shown in the drawing, the handle gut hook leading edge 34 has a rounded corner, and is thus generally incapable of making an incision or damaging meat or other tissue, while the sharpened gutting blade 14 is exposed.

As generally shown in FIGS. 1 and 7, the cutting instrument 2 has a skinning blade 12 and a gutting blade 14 which may be integrally interconnected in one embodiment of the present invention, and which may be selectively removed once it becomes dull. As shown in FIG. 1, a blade retention screw 16 is shown which is rotated in one embodiment to allow the release of the skinning blade 12 and cutting blade 14, and which allows for the insertion of a replacement blade. As further shown in FIG. 7, a blade guard 18 is shown removed from the skinning blade 12 and may be used to protect a user's hand and shroud the blade cutting edge. A similar type of blade guard 18 may also be used for the gutting blade 14 and which may snapped into place when a specific blade is not being used. More specifically, in one embodiment a blade guard 18 for the gutting blade 14 is provided which encloses not only the blade, but also wraps around the gut hook exterior portion 24. The blade guard 18 preferably snaps to a closed position, and is simply unsnapped for removal. The skinning blade 12 and cutting blade 14 are generally comprised of a rigid metallic material, and more specifically a stainless steel iron alloy with a certain hardness which allows sharpening, but which does not dull easily after repeated use. Preferably, the skinning blade 12 and cutting blade 14 are comprised of a carbon and stainless steel alloy.

The cutting instrument 2 of the present invention generally has a shape which is generally adapted for use by an adult with a full sized hand. Alternatively, smaller dimensions may be implemented for use by women or those with smaller hands. By creating the handle with a dimension of at least about 3 inches, a user's fingers may be completely shrouded and protected during a butchering or skinning operation of a game animal, and thus provides additionally safety during use. Furthermore, the handle 4 has an enclosure which is generally large enough to facilitate a user wearing gloves during use, and thus has an internal opening with a dimension of at least about 1 inch. As appreciated by one skilled in the art, the exact shape of the handle 4 is not important with regard to the novelty of the invention with the exception of the fingers being shrouded and protected during use. As appreciated by one skilled in the art, the ergonomics of the interior portion of the handle outer perimeter shape and the handle interior perimeter shape are important, and as provided herein, they are shaped to facilitate a repetitive motion in two distinct positions of use without causing significant hand fatigue. The exact shape and dimensions are not critical as long as the handle is capable of being used in two distinct positions of use and is comfortable in a user's hand during repetitive use.

While an effort has been made to describe various alternatives to the preferred embodiment, other alternatives will readily come to mind to those skilled in the art. Therefore, it should be understood that the invention may be embodied in other specific forms without departing from the spirit or central characteristics thereof. Present examples and embodiments, therefore, are to be considered in all respects as illustrative and not restrictive, and the invention is not intended to be limited to the details given herein.

| # | Component |
|---|---|
| 2 | Cutting instrument |
| 4 | Handle |
| 6 | Handle outer perimeter edge |
| 8 | Handle internal perimeter edge |
| 10 | Handle gut hook |
| 12 | Skinning blade |
| 14 | Gutting blade |
| 16 | Blade retention screw |
| 18 | Blade guard |
| 20 | Protruding studs |
| 22 | Gut hook interior portion |
| 24 | Gut hook exterior portion |
| 26 | Skinning blade cutting edge |
| 28 | Gutting blade cutting edge |
| 30 | Handle upper end |
| 32 | Handle lower end |
| 34 | Handle gut hook leading edge |
| 36 | Blade support member |

1. A dual bladed cutting instrument adapted for use in two distinct positions of use, comprising:
an enclosed handle comprising a lower end, an upper end, an exterior perimeter edge and an interior perimeter edge, wherein a user's fingers are adapted for positioning on said interior perimeter edge and the user's thumb is adapted for positioning on an exterior perimeter edge, wherein the user's fingers are generally shrouded from contacting a first blade or a second blade of the dual bladed cutting instrument.

2. The cutting instrument of claim 1, further comprising a blade retention screw positioned in a portion of the enclosed handle, wherein said first blade and said second blade may be selectively removed.

3. The cutting instrument of claim 1, wherein said first blade and said second blade are integrally interconnected.

4. The cutting instrument of claim 1, wherein said first blade is a skinning blade and said second blade is a gutting blade.

5. The cutting instrument of claim 1, wherein said enclosed handle is interconnected to a blade support member which retains said first blade and said second blade.

6. The cutting instrument of claim 1, wherein said enclosed handle is adapted for use in two distinct positions in a user's hand, wherein in a first position said first blade is used and in a second position said second blade is used.

7. The cutting instrument of claim 1, further comprising a stud projecting from said exterior perimeter edge of said enclosed handle on said gut hook, wherein the stud is adapted for scraping the entrails of a fish.

8. The cutting instrument of claim 1, further comprising at least one selectively removable blade guard that is adapted to cover said at least one of said first blade and said second blade.

9. The cutting instrument of claim 1, wherein said enclosed handle is comprised of at least one of a plastic, a wood, a fiberglass and a metal material.

10. A two-bladed field dressing knife adapted for use in two distinct positions, comprising:
an enclosed handle defined by a lower end, an upper end, an exterior perimeter edge and an interior perimeter edge, said enclosed handle adapted to shroud at least a user's fingers within said interior perimeter edge;
a blade support member interconnected to said upper end of said enclosed handle;
a first blade operably interconnected to a first portion of said blade support member, said first blade comprising at least one cutting edge oriented in a first direction;
a second blade operably interconnected to a second portion of said blade support member, said second blade having at least one cutting edge oriented in a second direction which is distinct from said first position, wherein a user holds said enclosed handle in a first position of use to utilize said first blade and a second position of use to utilize said second blade.

11. The field dressing knife of claim 10, wherein said first blade and said second blade are integrally interconnected.

12. The field dressing knife of claim 10, wherein at least one of said first blade and said second blade are removably interconnected to said blade support member.

13. The field dressing knife of claim 10, wherein said blade support member further comprises a hook shaped member which substantially encircles at least a portion of said second blade.

14. The field dressing knife of claim 10, wherein at least one of said exterior perimeter edge and said interior perimeter edge is ergonomically shaped to receive a user's fingers or a thumb.

15. The field dressing knife of claim 10, further comprising at least one selectively removable blade guard which is adapted to cover at least one of said first blade and said second blade.

16. A cutting instrument with a shrouded handle which is adapted to substantially enclose a user's fingers during use, comprising:
an ergonomically shaped enclosed handle having a first geometric profile defined by an exterior perimeter shape and a second geometric profile defined by an interior shape, wherein a user's fingers are adapted for engagement with the interior shape and a user's thumb is adapted for engagement with the exterior shape;
a first cutting blade projecting from a blade support member interconnected to an upper portion of the ergonomically shaped enclosed handle, wherein a user's fingers are shrouded within the ergonomically shaped handle and substantially protected from contact with said at least one cutting blade.

17. The cutting instrument of claim 16, further comprising a second cutting blade which is oriented in a direction which is distinct from said first cutting blade.

18. The cutting instrument of claim 16, wherein said first cutting blade and said second cutting blade are integrally interconnected.

19. The cutting instrument of claim 16, wherein said first cutting blade and said second cutting blade are removably interconnected to said blade support member.

20. The cutting instrument of claim 19, wherein said blade support member at least partially shrouds a portion of said second blade with a handle gut hook, wherein said cutting instrument may be used in a pulling motion.
